(19) United States
(12) Patent Application Publication
(10) Pub. No.: US 2003/0096632 A1
(43) Pub. Date: May 22, 2003

(54) Speaker assembly for mobile phones

(75) Inventors: Bok-Beum Kim, Suwon (KR); Man-Dae Han, Suwon (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd

(21) Appl. No.: 10/044,966

(22) Filed: Jan. 15, 2002

(30) Foreign Application Priority Data
Nov. 16, 2001 (KR) 2001-71502

(51) Int. Cl. H04B 1/38

(52) U.S. Cl. 455/550; 455/90

(57) ABSTRACT

Disclosed herein is a speaker assembly for mobile phones. The speaker assembly having a main board covering the back surface of the speaker includes an air duct mounted on the back surface of the speaker such that the air duct penetrates the main board, thus allowing air to circulate from the speaker to a region behind the speaker without suffering resistance by a main board or other components of the speaker assembly, therefore maximizing resonance effect of the speaker. The present invention is directed to provide a speaker assembly for mobile phones, having improved sound quality.

### BACKGROUND OF THE INVENTION

1. Field of the Invention

The present invention relates generally to speakers for mobile phones, and more particularly, to a speaker for mobile phones, which is provided on its back surface with an air duct, thus ensuring smooth air circulation, therefore improving sound quality of the speaker.

2. Description of the Prior Art

Generally, mobile phones are all kinds of portable wireless phones, including cellular phones, PCS phones, PDA (Personal Digital Assistants), IMT-2000, and others. The mobile phones each are provided with a speaker for transceiving characteristic signals.

The speaker is designed to transduce electrical energy into mechanical energy by a voice coil, according to Fleming's left-hand law. Fleming's left-hand law states that a magnetic force is applied to a live conductor when the conductor is in a magnetic field.

That is, when an electric signal with a variety of frequencies is sent to the voice coil, the voice coil generates mechanical energy depending on a current intensity and a frequency magnitude, and then a diaphragm attached to the voice coil is vibrated. Through this process, a sound pressure of an audible magnitude is generated.

FIG. 1 schematically shows a conventional speaker assembly for mobile phones, as an example.

Referring to FIG. 1, the cover of a mobile phone consists of a front cover 10 and a rear cover 20. A main board 30 is installed between the front cover 10 and the rear cover 20, and processes various kinds of data. A speaker 40 is installed between the front cover 10 and the main board 30.

An extension wall 12 perpendicularly extends from the inner surface of the front cover 10 in such a way as to form a mounting space 14 having a diameter which is equal to or longer than that of the speaker 40. The speaker 40 is installed in the mounting space 14. The front cover 10 has a plurality of sound holes 16.

The main board 30 is mounted on top of the extension wall 12. The rear cover 20 is assembled with the front cover 10 in such a way as to be spaced apart from the main board 30 at a predetermined interval.

However, the conventional speaker assembly has a problem that the rear section of the speaker 40 is blocked by the main board 30, so air cannot circulate from the rear section of the speaker 40 to the space formed between the main board 30 and the rear cover 20, and thus desirous resonance effect can not be achieved, therefore deteriorating the sound quality of the speaker.

In order to solve the above problem, a method of forming an air circulation passage by cutting out a part of the main board 30 has been proposed. However, a conventional speaker assembly constructed in this way has a problem in that the surface area of the main board 30 is reduced, thus undesirably reducing the area for arranging several components of a mobile phone.

### SUMMARY OF THE INVENTION

Accordingly, the present invention has been made keeping in mind the above problems occurring in the prior art, and an object of the present invention is to provide a speaker assembly for mobile phones, which is provided on the back surface of its speaker with an air duct, thus ensuring smooth air flow from the speaker, therefore improving sound quality of the speaker.

In order to accomplish the above object, the present invention provides a speaker assembly for mobile phones having a main board covering the back surface of a speaker, including an air duct mounted on the back surface of the speaker such that the air duct penetrates the main board, thus allowing air to circulate from the speaker to a region behind the speaker.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view schematically showing a conventional speaker assembly for mobile phones;

FIG. 2 is a sectional view of a speaker assembly for mobile phones according to the primary embodiment of the present invention; and

FIG. 3 is a sectional view of a speaker assembly for mobile phones according to the second embodiment of this invention.

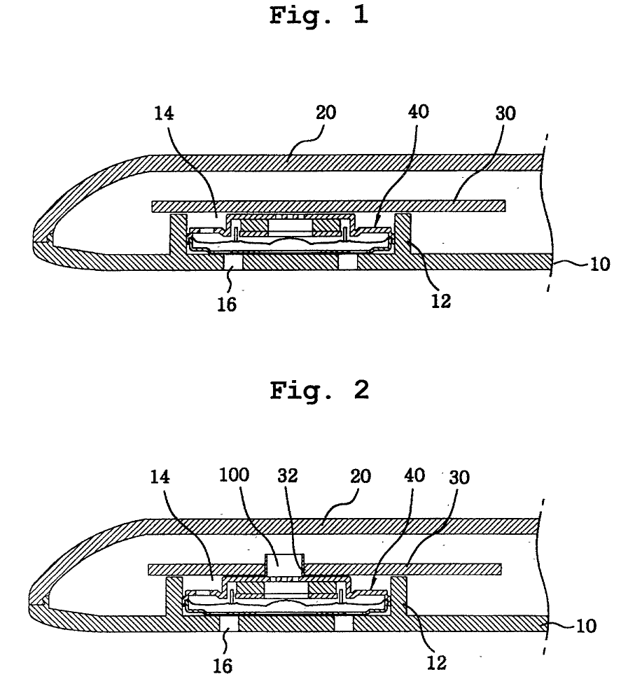

### DESCRIPTION OF THE PREFERRED EMBODIMENTS

Reference now should be made to the drawings, in which the same reference numerals are used throughout the different drawings to designate the same or similar components.

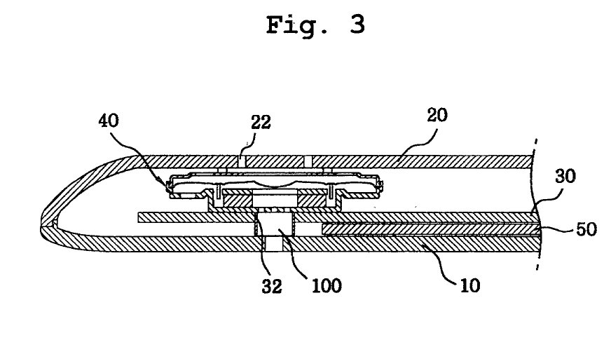

FIG. 2 is a sectional view of a speaker assembly for mobile phones according to the primary embodiment of the present invention, and FIG. 3 is a sectional view of a speaker assembly for mobile phones-of the second embodiment of this invention.

Typically, a mobile phone is designed to fold its cover over a body. The present invention relates to an air duct of a speaker installed in the cover of such a mobile phone.

Referring to FIG. 2, the cover of the mobile phone according to this invention consists of a front cover 10 and a rear cover 20. The front cover 10 has a plurality of sound holes 16. The rear cover 20 is assembled with the front cover 10 in such a way as to form a predetermined cavity between two covers 10 and 20.

A main board 30 is installed in the cavity formed between the front and rear covers 10 and 20, and processes various kinds of data. A speaker 40 is also installed in the cavity formed between the front and rear covers 10 and 20, and generates a sound pressure of a predetermined magnitude.

An extension wall 12 is vertically erected on the inner surface of the front cover 10 provided with the sound holes 16, in such a way as to form a mounting space 14 having a diameter which is equal to or longer than that of the speaker 40. The speaker 40 is installed in the mounting space 14.

Since a conventional speaker can be used as the speaker 40 of the present invention, the speaker 40 will not be described in detail herein.

The main board 30 is attached to the top of the extension wall 12 in such a way as to cover the back surface of the speaker 40. A predetermined space is formed between the main board 30 and the rear cover 20.

An air duct 100 is connected at its end to the back surface of the speaker 40 and extends toward the region behind the speaker 40. The air duct 100 extends through a through hole 32 formed by penetrating the main board 30. This air duct 100 allows air to smoothly circulate from the speaker 40 to the space formed between the rear cover 20 and the main board 30.

It is desirable that the through hole 32 should be formed at an appropriate position of the main board 30 in such a way as not to affect the operation of the other components arranged on the main board 30.

The operation and effect of this invention constructed in this way will be described in the following.

According to this invention, air smoothly circulates from the speaker 40 to the space formed between the rear cover 20 and the main board 30, thus improving the sound quality of the speaker 40.

That is, air smoothly circulates from the speaker 40 to the space defined between the rear cover 20 and the main board 30 without suffering resistance by the main board 30 or other components, and obtains resonance effect produced in the space. Therefore, a low frequency band of sound which is audible from the speaker 40 is complemented, and thus the sound quality of the speaker 40 is improved.

In the second embodiment of FIG. 3, the general shape of the speaker assembly remains the same as in the primary embodiment, but the speaker 40 of the second embodiment is installed to face the rear cover 20.

The second embodiment of this invention will be briefly described in regard to aspects thereof which are different from the primary embodiment. That is, a speaker 40 is installed to face its front surface toward a rear cover 20. The rear cover 20 has a sound output hole 22 at a position corresponding to the speaker 40.

A main board 30 is attached to the back surface of the speaker 40. A display 50 is interposed between a front cover 10 and the main board 30.

An air duct 100 is connected at its first end to the back surface of the speaker 40 and penetrates the main board 30 in such a way as to be connected at its second end to the front cover 10 while surrounding the edge of the sound hole 16.

The speaker assembly of the second embodiment has an advantage that the sound quality of the speaker 40 is improved, in the same manner as that of the primary embodiment. In addition, since the speaker 40 is installed to face the rear cover 20 and the main board 30 is moved toward the front cover 10 to be close to the display 50, it is possible to more flexibly design the mobile phone to be thinner than conventional mobile phones, in terms of the whole thickness of the mobile phone.

Furthermore, since the speaker 40 is arranged in order not to interfere with the display 50 when designing mobile phones, the window of the display 50 can have a larger size, in comparison with conventional mobile phones. Therefore, mobile phones can be designed to have various shapes, thus having more excellent market competitiveness.

As described above, the present invention provides a speaker assembly for mobile phones, which allows air to smoothly circulate from a speaker to a region behind the speaker without suffering resistance by a main board or other components of the speaker assembly, therefore improving sound quality of the speaker.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A speaker assembly for mobile phones having a main board covering a back surface of a speaker, comprising:
an air duct mounted on the back surface of the speaker such that the air duct penetrates the main board, thus allowing air to circulate from the speaker to a region behind the speaker.

2. A speaker assembly for mobile phones, comprising:
a front cover having a plurality of sound holes formed therethrough;
a rear cover assembled with the front cover in such a way as to form a predetermined cavity between the front and rear covers;
a speaker installed in said cavity in such a way as to face the sound holes of the front cover, and generating a sound pressure of a predetermined magnitude;
a main board attached to a back surface of the speaker for processing various kinds of data, and having a through hole communicating with a rear section of the speaker; and
an air duct connected at an end thereof to the back surface of the speaker and extending through the through hole of said main board,
whereby the air duct allows air to circulate from the rear section of the speaker to a-space formed between the main board and the rear cover.

3. A speaker assembly for mobile phones, comprising:
a front cover having a sound hole formed therethrough;
a rear cover assembled with the front cover in such a way as to form a predetermined cavity between the front and rear covers, and having a plurality of sound output holes at a position corresponding to said sound hole;
a speaker installed in said cavity in such a way as to face the sound output holes of the rear cover;
a main board attached to a back surface of the speaker for processing various kinds of data, and having a through hole communicating with a rear section of the speaker;
a display interposed between the main board and the front cover; and
an air duct connected at a first end thereof to the back surface of the speaker, and extending through the through hole of the main board in such a way as to be connected at a second end thereof to the front cover while surrounding an edge of the sound hole of said front cover,
whereby the air duct allows air to circulate from the rear section of the speaker to the outside of the front cover.
